(19) United States
(12) Patent Application Publication
(10) Pub. No.: US 2019/0161921 A1
(43) Pub. Date: May 30, 2019

(54) ROAD CONSTRUCTION MACHINE AND METHOD FOR OPERATING A SELF-PROPELLED ROAD CONSTRUCTION MACHINE

(71) Applicant: Dynapac GmbH, Wardenburg (DE)

(72) Inventors: Thorsten SCHWARTING, Wardenburg (DE); Christian FASCHE, Wildeshausen (DE)

(73) Assignee: Dynapac GmbH, Wardenburg (DE)

(21) Appl. No.: 16/308,470

(22) PCT Filed: Jun. 9, 2017
(86) PCT No.: PCT/EP2017/000672

§ 371 Date: Dec. 9, 2018

(30) Foreign Application Priority Data
Jun. 10, 2016 (DE) 10 2016 007 076.5

(51) Int. Cl. E01C 19/27

(52) U.S. Cl. CPC E01C 19/27; B60C 23/001

(57) ABSTRACT

A method for operating a self-propelled road construction machine as well as a road construction machine with which an adjustment of the traction of the wheeled undercarriage can be performed in a quick and easy manner by monitoring and actively regulating the traction of the tires in dependence on the operating mode of the road construction machine. Pavers and feeders for the making of road covers have a wheeled undercarriage, especially with pneumatic tires. For a uniform production process of the road cover, adequate traction of the tires is needed. For this, prior to the start of the production process the tire air pressure of the tires is decreased, and it is increased once again for travel on the road, and the manual adjustment of the tire air pressure to the installation conditions and/or to the operating mode of the road construction machine is time consuming and cost intensive.

### CROSS REFERENCE TO RELATED APPLICATIONS

This application is the National Phase of and claims priority on and the benefit of International Application No. PCT/EP2017/000672 having an international filing date of 9 Jun. 2017, which claims priority on and the benefit of German Patent Application No. 102016007076.5 having a filing date of 10 Jun. 2016.

### BACKGROUND OF THE INVENTION

### Technical Field

The invention relates to a method for operating a self-propelled road construction machine, especially a paver or a feeder for producing a road cover with an undercarriage having driven tires. Furthermore, the invention relates to a road construction machine, especially a paver or a feeder, having an undercarriage, comprising driven tires.

### Prior Art

Pavers and feeders serve for the making of road covers made of asphalt, but also those made of other road construction materials, such as concrete. The road construction material being worked is transported by truck to the construction site and there it is either dumped directly into a reservoir tank of the paver or the reservoir tank of the feeder, which then further conveys it to the paver. The road construction material is dumped from the truck into the reservoir tank of the paver or the feeder during the advancing movement of the self-propelled paver or feeder. In this process, the paver or the feeder pushes the truck in front of it.

Pavers and feeders have an undercarriage for the installation operation and also for the transport or for short travel on the roads. This undercarriage may be designed as a wheeled undercarriage or as a tracked undercarriage. The wheeled undercarriage of a paver generally has both pneumatic tires and all-rubber wheels. The air-filled tires are generally positioned on the rear end of the paver as drive wheels in the production direction of the paver. The all-rubber wheels may likewise be designed as drive wheels and are situated in front of the drive tires, looking in the production direction. Feeders may likewise have air-filled tires which are driven by a drive unit, such as a Diesel engine for example.

For the installation process of the road construction material, a paving screed of the paver is lowered onto the road cover being produced or onto the road construction material and pulled in the production direction over the material, so that it is consolidated. The paving screed, in this case, generally lies floating on the road construction material. In order for the paver as well as the feeder to be able to move uniformly on the ground base on which the road cover is intended to be applied during the production process for the road cover, a sufficient traction of the drive tires or wheels is needed, i.e., the slippage of the undercarriage should be kept as little as possible. Even the lightest slippage of the tires may result in unwanted irregularities in the road cover, having a detrimental effect on the surface texture of the road cover being produced. Therefore, prior to the start of the production process the tire air pressure of the drive tires is reduced, so that the bearing surfaces of the tires against the ground base is increased and therefore the traction is increased. For subsequent travel on the road or for the transport of the paver or the feeder, however, a low tire air pressure is detrimental, since this reduces the driving stability and the driving comfort, and also the fuel consumption is very high. After the end of the installation process, the air pressure of the tires is therefore increased once more.

The same changes in the tire air pressure are necessary for a changing ground base. Thus, for example, the traction of the tires is different for bonded sand or gravel. In order to have an adequate traction here as well, the air pressure of the tires must be adapted accordingly.

Since the adapting of the tire air pressure to the installation conditions and/or to the operating mode of the road construction machine is done manually by an operator, the installation process proves to be especially time consuming and cost intensive.

### BACKGROUND OF THE INVENTION

The problem underlying the invention is to create a method for operating a self-propelled road construction machine as well as a road construction machine with which the traction of the undercarriage can be adapted in a quick and easy manner.

A method for solving this problem is a method for operating a self-propelled road construction machine, especially a paver or a feeder for producing a road cover with an undercarriage having driven tires, characterized in that the traction of the tires of the undercarriage is monitored and actively regulated in dependence on the operating mode of the road construction machine. Accordingly, it is provided that the traction of the tires of the undercarriage is monitored and actively regulated in dependence on the operating mode of the road construction machine. Thanks to this monitoring of the traction of the driven tires, the optimally suited traction can be adjusted for each operating mode of the road construction machine. Hence, with this active regulation, the necessary high traction of the tires can be assured during the installation phase of the road construction material and/or the traction can be regulated during travel on the road of the road construction machine so that the fuel consumption and the tire wear are minimal.

In particular, it may be provided that the monitoring and active regulating of the traction during the operation of the road construction machine are done automatically or manually and independently of each other for each tire, especially for each rear tire, looking in the production direction. At construction sites or ground bases on which the road construction material is being applied, it may occur that the driven tires, especially a left and a right tire, have different tractions or a different slippage on account of a sandy ground base, for example. In this case, each tire can be actuated and driven individually and independently of the other tires. Thanks to the active traction or slippage monitoring for each individual drive tire, an optimal traction of the road construction machine can be achieved during the operation. This monitoring may be performed either fully automatically through a control device or a monitoring unit, or by hand by an operator of the road construction machine.

Preferably, the present invention may further provide that the active regulating of the traction of the tires is done by changing the tire air pressure, in particular that the tire air pressure is increased during travel on the road or during transport and the tire air pressure is decreased during an installation process of the road cover. By decreasing the tire air pressure of the driven tires or the rear tires, the bearing surface of the tires on the ground base is increased, so that the frictional resistance and thus the traction of the tires is increased. This regulation can be done individually for each individual tire and independently of the others. In this way, the road construction machine has a sufficiently large traction during the installation phase of the road construction material or the tire air pressure is reduced so much that an adequate traction results. The optimal value for the tire air pressure is always to be determined here, said value achieving a minimal fuel consumption in the case of an optimal traction. For the travel on the road or the transport of the paver or feeder, the tire air pressure is then increased once again in order to reduce the bearing surface of the tires on the ground base and decrease the fuel consumption.

A further special exemplary embodiment of the present invention may provide that the active regulating of the traction of the tires is done by changing the screed load relief of a paving screed of the road construction machine, especially the paver, preferably that the load relief of the paving screed is increased in order to increase the traction, i.e., the built-in screed is at least slightly raised, so that the load on the tires is increased. For the production of the road cover, the road construction material is delivered from a reservoir tank of the paver through a conveyor in front of a distributing worm. This distributing worm distributes the still warm road construction material over the entire width of the road cover being installed. Then the paving screed is pulled across the still warm road construction material. The paving screed is, in this case, connected by so-called support arms to the paver. In general, the paving screed moves in a floating manner over the road cover during an installation process. For a certain relieving of the load on the paving screed, the support arms can be moved by corresponding lifting cylinders so that the paving screed does not lie with its full weight on the road construction material. Now, in order to increase the traction of the drive tires of the paver, the paving screed can be relieved of load so much that the necessary traction results. Thanks to this regulating of the traction by changing the screed load relief, in addition to varying the tire air pressure a further possibility of regulating the traction of the road construction machine is created.

Further, the present invention may provide that the active regulating of the traction of the tires is done by changing the load relief of the screed and by changing the tire air pressure, in particular that the regulating of the traction may be done by the load relief of the screed in addition to a changing of the tire air pressure. Thus, it may be advantageous to first optimize the traction by changing the tire air pressure in order then, if this still does not result in a satisfactory outcome, to further optimize the traction of the road construction machine through the screed load relief.

Preferably, it may be furthermore provided that the tire air pressure is determined, preferably permanently, by a tire pressure monitoring unit for the monitoring and active regulating of the tire air pressure of all tires during the operation of the road construction machine, in particular that a tire air pressure loss of the tires is determined by the tire pressure monitoring unit. This tire pressure monitoring unit may be located either inside the tires or outside them. In particular, thanks to the continuous or permanent monitoring of the tire air pressure it is also possible to determine a tire pressure air loss, for example due to damaging of the tire. However, the tire pressure monitoring unit serves primarily for determining the actual tire pressure, in order to create in this way any necessary change in the pressure for an optimal traction of the undercarriage. Either the tire air pressure measured by the tire pressure monitoring unit is optimized directly in dependence on the traction measured by the traction control or this is done with a reference value table containing predetermined traction values for given tire air pressures. This can prevent a too high or a too low relative tire air pressure, which would cause too high a fuel consumption and a lack of driving stability or an inadequate driving comfort. Furthermore, this step can reduce the fuel consumption.

Thanks to this constant feedback loop or regulating circuit, a manual filling to be frequently performed and bleeding of the air-filled tires can be avoided, since it will be automated. This has the advantage, in particular, that the installation process of the road construction material can be done more quickly and economically. Furthermore, thanks to the optimal traction, larger working widths or installation thicknesses of the road construction machine can be realized. Rather, the invention also provides for regulating or optimizing the traction in dependence on the layer thickness and/or the working width. The layer thickness and/or the working width can be determined directly by sensors and directly from the control unit. Furthermore, thanks to this method, a simple and process-safe adapting of the tire air pressure to different ground bases can be done, such as bonded sand, gravel, asphalt or the like for example.

Thanks to the continual monitoring of the tire air pressure, a safe operating condition of the tires at all times and an early recognizing of tire damage furthermore occur. This assured mobility of the road construction machine is essential for a trouble-free production process of the road cover.

Furthermore, it may be provided that the traction of the tires of the undercarriage is monitored and actively regulated in dependence on the ground base on which the road construction material is being installed, and/or on the thickness of the layer of the road construction material and/or the installation width of the road construction material. For greater installation width, increased traction is needed in order to compact the road construction material uniformly by the paving screed and to a sufficient extent. Furthermore, with a larger installation width, the bearing surface of the paving screed on the road construction material and thus the frictional resistance of the screed on the material that needs to be overcome for the installation of the cover is increased.

In particular, it may be provided that the speed of the road construction machine is changed, in particular reduced, preferably automatically, in the event of a changing, especially decreasing tire air pressure and/or in the event of a changed, especially decreased screed load relief. Thanks to this connection of the active monitoring of the tire air pressure to a control unit of the road construction machine for the purpose of proactive speed regulation and/or for the purpose of traction increasing, an optimal installation outcome of the road construction material can be achieved. The speed of the road construction machine will be adapted accordingly, depending on the size of the traction or the tire air pressure or the screed load relief.

Furthermore, it may be provided that reference values of the tire air pressure are recalibrated for the monitoring and regulating of the traction in the event of a change of tires, especially a change of tire manufacturers. Since in particular the deformability of tires may differ from one manufacturer to another, this is necessary in the event of a change of tires, especially a change of manufacturers. Thanks to this recalibration, which can be done automatically in particular, the traction control can be done reliably as usual even after such a change.

Preferably, the present invention may also provide that the active regulating of the traction of the tires is performed through additional weights or through compound disk wheels or through filling air into tires having at least two separate air chambers. In particular, the compound disk wheels allow tires or wheels to be changed especially quickly and easily, which is important for the most trouble-free possible installation process of the road construction material.

A road construction machine for the solving of the aforementioned problem is a road construction machine, especially a paver or feeder, having an undercarriage, comprising driven tires, characterized by an automatic or manually activatable traction control device for the active traction control of the tires with a tire pressure monitoring unit, wherein the traction of the driven tires can be adapted accordingly during the running of the operating mode by a measurement of the tire pressure. Accordingly, it is provided that the road construction machine, especially a paver or feeder, has an automatic or manually activatable traction control device for the active traction control of the tires with a tire pressure monitoring unit. Here, the traction of the driven tires can be adapted accordingly during the running of the operating mode by a measurement of the tire pressure. Thanks to this traction control device, which serves for the active traction control, a rapid and reliable changing of the traction of the tires can be done during the operation and in dependence on the operating mode.

Furthermore, it may be provided that the traction control device has at least one compressor with which an air tank can be filled with compressed air, a tank pressure switch, a tank pressure manometer and a preselect pressure manometer, for regulating the air pressure, a preselect unit, a tire pressure monitoring unit and a regulating unit, as well as connection points for the compressed air on the tires. The compressor of the traction control besides the use described here for the regulating of the tire air pressure can also be used to supply other compressed air tools. Furthermore, the compressor may be used for cleaning of machines, equipment, and the construction site. The compressor can moreover be used to operate a drill for taking samples, (drill cores). The compressor need not be connected permanently to the road construction machine in this case. Instead, it can also be designed as a mobile compressor, which can also be detached from the road construction machine and brought to the site of use. The compressor can furthermore be associated as a mobile compressor unit with a retrofit unit. Thanks to the use of the automatic or manually activatable traction control device, the minimum or maximum installation thickness can be optimally decreased or increased. By ensuring an optimal tire air pressure for an adequate traction and this being attuned to both drive tires, an enhanced process security of the installation process can be achieved. Thanks to the permanent monitoring of the tire air pressure, downtime of the road construction machine on account of slowly progressive tire damage can be prevented. Furthermore, the regulating of the tire air pressure can also regulate the clearance or transport height for travel beneath bridges or through tunnels or similar structures. Moreover, the ramp angle and the loose fill height of the reservoir tank can be adapted and increased or decreased in this way.

In one preferred modification of the present invention it can furthermore be provided that the traction control device comprises at least one sensor for determining the operating mode and/or one sensor, preferably one sensor for each tire, for determining the traction, especially the slippage. By this monitoring of the operating mode and the actual traction, this also can be optimally adapted according to the external circumstances.

Furthermore, another preferred exemplary embodiment of the present invention may provide that the traction of the tires can be regulated through the traction control device by changing a screed load relief of a paving screed. This regulating of the traction by changing the screed load relief creates an alternative to the traction control based on the tire pressure regulation.

The invention can moreover provide that the compressor is hydraulically, electrically, or mechanically drivable or has its own drive unit. For this, the compressor may have an internal combustion engine, for example.

A further exemplary embodiment may provide that the traction control device and/or the compressor are/is permanently connected to the tires, especially to the tire inside or outside or the wheel hub, or that the traction control device and/or the compressor are/is not permanently connected to the tires. In particular, a connection of the air pressure line to the tires via the wheel hub proves to be especially advantageous, since in this way the tire air pressure can also be increased or decreased during the operation. Through this permanent connection of the compressor or the traction control device to the tires an ongoing monitoring and regulating of the traction can be achieved, which in turn results in a trouble-free installation of the road cover.

Another exemplary embodiment may provide that the tires have weights for the traction control or that the tires are composed of a compound disk wheel, consisting of at least one wheel disk and an outer rim ring, or that the tires each have two separate air chambers. In particular, the design of the tires as a compound disk wheel ensures a quick tire change during the operation of the road construction machine, with no long waiting time. Furthermore, the traction of the tires can be regulated especially precisely through the additional weights or the separate air chambers of the tires.

### BRIEF DESCRIPTION OF THE DRAWINGS

A preferred exemplary embodiment of a road construction machine according to the invention shall be explained more closely below with the aid of the drawing. This shows:

FIG. 1 is a schematic side view of a construction machine, namely, a paver, and

FIG. 2 is a block diagram of a traction control device.

### DETAILED DESCRIPTION OF PREFERRED EMBODIMENTS

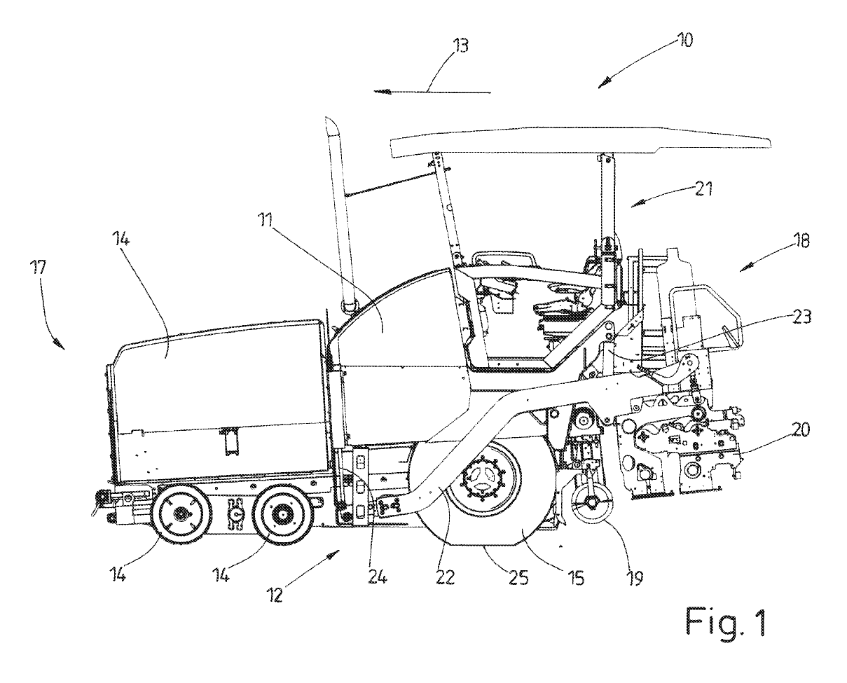

A paver 10 shown schematically in FIG. 1 serves for the production of road covers. These can be a road cover of any given kind.

The paver 10 has a self-propelled design. For this, it comprises a central drive unit 11, which is formed for example by an internal combustion engine, the hydraulic pumps for the powering of hydraulic motors, and optionally a generator for creating energy for electric drives and compressors.

The paver 10 has an undercarriage 12, which in the exemplary embodiment shown in FIG. 1 is designed as a wheeled undercarriage. The undercarriage 12 is driven by the drive unit 11 such that the paver 10 can be moved forward in the production direction 13. The undercarriage 12 has wheels 14 at a front part of the paver 10, looking in the production direction 13, which are formed as all-rubber wheels in the exemplary embodiment depicted here. A pair of tires 15 is associated with the rear part of the paver 10, looking in the production direction 13. These tires 15 serve as drive tires and are air-filled.

Looking in the production direction 13, a tub or trough-shaped reservoir tank 14 is arranged in front of the drive unit 11. The reservoir tank 14 holds a supply of the material serving for the production of the road cover, such as asphalt. Optionally, several reservoir tanks may also be provided. The road construction material may either be loaded into the reservoir tank 16 by a truck, not shown, having driven up to the front end 17 of the paver. However, it is also conceivable for the road construction material to be loaded into the reservoir tank 16 via a feeder, not shown, which is likewise arranged at the front end 17 of the paver 10.

By delivery members, not shown, the road construction material is transported from the reservoir tank 14 beneath the drive unit 11 through to the rear end 18 of the paver 10, in the production direction 13. From a distributing worm 19 arranged behind the undercarriage 12, the road construction material is distributed over the entire working width of the paver 10. In this process, a supply of the road construction material ends up in front of a paving screed 20, suspended from the undercarriage 12 and able to move up and down behind the distributing worm 19.

Furthermore, the paver 10 shown in FIG. 1 has an operator's station 21, from which the paver 10 can be controlled by an operator, not shown.

In order to produce the road cover, the still hot road construction material is deposited by the distributing worm 19 in front of the paving screed 20 and compacted by the paving screed 20. For this, the paving screed 20 suspended from the support arms 22 is set down on the road construction material and pulled by the paver 10 across the material. The support arms 20 are moved up and down in this process by lifting cylinders 23 and leveling cylinders 24. During the installing of the road construction material, the paving screed 20 floats on the road construction material. To relieve the load on the paving screed 20, the support arms 22 or the paving screed 20 may be raised by the lifting cylinder 23 or leveling cylinder 24.

For a uniform installing of the road cover and thus for the production of a trouble-free cover, it is important for the tires 15 to have adequate traction on the ground base 25.

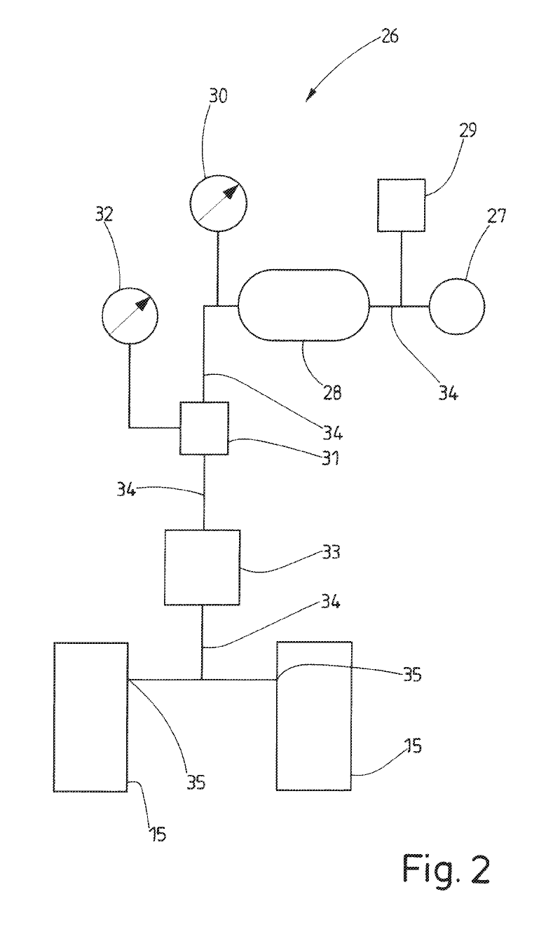

FIG. 2 shows, highly schematized, a block diagram of a traction control device 26. This traction control device 26 shown in FIG. 2 stands in direct connection with the two drive tires 15. However, it is precisely provided, according to the invention, that the traction control device 26 regulates the screed load relief of the paving screed 20. For this, the traction control device 26 actuates the lifting cylinder 23 or the leveling cylinder 24.

The traction control device 26 shown in FIG. 2 has a compressor 27. This compressor generates compressed air and is driven either through its own drive or through the drive unit 11 or auxiliaries. The compressor 27 is assigned an air tank 28, in which compressed air can be stored. In order to always store an adequate quantity of compressed air in the tank 28, the air tank 28 is assigned a tank pressure switch 29 and a tank pressure manometer 30. Furthermore, the traction control device 26 has a preselect unit 31 with a preselect pressure manometer 32 and a regulating unit 33. In order to be able to actuate the tires 15 accordingly, a pressurized air line 34 leads from the compressor 27 to the tires 15. This pressurized air line 34 is connected across connection points 35 to the tires 15. These connection points 35 may be, for example, the wheel hub of the tires 15.

Furthermore, the tires 15 are connected at least to the regulating unit 33 by pressure sensor means, not shown. These sensor means determine the pressure in both tires 15 continually or in a timed manner or according to a manual input and transmit this value to the regulating unit 33. Then, depending on the predetermined operating mode, the air pressure in the tires 15 is regulated. For this, the tire air pressure can be increased by means of air from the air tank 28 or the compressor 27 or the pressure in the tires 15 can be reduced by bleeding or extracting of the compressed air. Furthermore, the regulating unit 33 is connected directly to a traction measuring device for both tires 15. Once this traction measuring device ascertains a lack of traction, the tire air pressure is changed accordingly. The tire air pressure will be changed until the traction is optimal, and at the same time a minimal consumption is achieved for the drive unit 11.

Besides the traction control and regulating of the tires 15 via the tire air pressure, the traction regulation can also be done by variation of the screed load relief of the paving screed 20. For this, the regulating unit 33 in the case of a determined lack of traction relays a corresponding signal to the lifting cylinder 23 or to the leveling cylinder 24. The regulating unit 33 ascertains for this an optimal interconnection of the traction regulation by altering the tire air pressure and the screed load relief.

Likewise, the traction for a feeder is regulated by measuring the tire air pressure of the drivable tires and regulating and increasing or reducing the tire air pressure of the drive tires according to the operating mode or the measured and required traction.

### LIST OF REFERENCE NUMBERS

10 Paver
11 Drive unit
12 Undercarriage
13 Production direction
14 Wheel
15 Tire
16 Reservoir tank
17 Front end
18 Rear end
19 Distributing worm
20 Paving screed
21 Operator's station
22 Support arm
23 Lifting cylinder
24 Leveling cylinder
25 Ground base
26 Traction control device
27 Compressor
28 Air tank
29 Tank pressure switch
30 Tank pressure manometer
31 Preselect unit
32 Preselect pressure manometer
33 Regulating unit
34 Pressurized air line
35 Connection point

1. A method for operating a self-propelled road construction machine, especially a paver (10) or a feeder for producing a road cover with an undercarriage (12) having driven tires (15), comprising monitoring and actively regulating the traction of the tires (15) of the undercarriage (12) in dependence on the operating mode of the road construction machine.

2. The method as claimed in claim 1, wherein the monitoring and active regulating of the traction during the operation of the road construction machine are done automatically or manually and independently of each other for each tire (15).

3. The method as claimed in claim 1, wherein the active regulating of the traction of the tires (15) is done by changing the tire air pressure, wherein tire air pressure is increased during travel on the road or during transport and the tire air pressure is decreased during an installation process of the road cover.

4. The method as claimed in claim 1, wherein the active regulating of the traction of the tires (15) is done by changing the load relief on a screed of a paving screed (20) of the road construction machine, especially the paver (10), preferably in that the load relief of the paving screed (20) is increased in order to increase the traction.

5. The method as claimed in claim 4, wherein the active regulating of the traction of the tires (15) is done by changing the load relief of the screed and by changing tire air pressure, in particular in that the regulating of the traction may be done by the load relief of the screed in addition to a changing of the tire air pressure.

6. The method as claimed in claim 1, wherein the tire air pressure is determined, preferably permanently, by a tire pressure monitoring unit for the monitoring and active regulating of the tire air pressure of all tires (15) during the operation of the road construction machine, wherein an air pressure loss of the tires (15) is determined by the tire pressure monitoring unit.

7. The method as claimed in claim 1, wherein the traction of the tires (15) of the undercarriage (12) is monitored and actively regulated in dependence on a ground base (25) on which the road construction material is being installed, and/or on a thickness of the layer of the road construction material and/or an installation width of the road construction material.

8. The method as claimed in claim 1, wherein the speed of the road construction machine is changed, in particular reduced, preferably automatically, in the event of a changing, especially decreasing tire air pressure and/or in the event of a changed, especially decreased screed load relief.

9. The method as claimed in claim 1, wherein reference values of tire air pressure are recalibrated for the monitoring and regulating of the traction in the event of a change of tires, especially in the event of a change of tire manufacturers.

10. The method as claimed in claim 1, wherein the active regulating of the traction of the tires (15) is performed through additional weights or through compound disk wheels or through filling air into tires (15) having at least two separate air chambers.

11. A road construction machine, especially a paver (10) or feeder, having an undercarriage (12) with driven tires (15), comprising an automatic or manually activatable traction control device (26) for the active traction control of the tires (15) with a tire pressure monitoring unit, wherein the traction of the driven tires (15) is adaptable accordingly during the running of the operating mode by a measurement of the tire pressure.

12. The road construction machine as claimed in claim 11, wherein the traction control device (26) further comprises at least one compressor (27) with which an air tank (28) can be filled with compressed air, a tank pressure switch (29), a tank pressure manometer (30) and a preselect pressure manometer (32), for regulating the air pressure, a preselect unit (31), a tire pressure monitoring unit and a regulating unit (34), pressurized air lines (34) and connection points (35) for the compressed air on the tires (15).

13. The road construction machine as claimed in claim 11, wherein the traction control device (26) further comprises at least one sensor for determining the operating mode and/or one sensor, preferably one sensor for each tire (15), for determining the traction, especially the slippage.

14. The road construction machine as claimed in claim 11, wherein the traction of the tires (15) is regulatable through the traction control device (26) by changing a screed load relief of a paving screed (20).

15. The road construction machine as claimed in claim 12, wherein the compressor (27) is hydraulically, electrically, or mechanically drivable or has its own drive unit.

16. The road construction machine as claimed in claim 12, wherein the traction control device (26) and/or the compressor (27) are/is permanently connected to the tires (15), especially to the tire inside or outside or the wheel hub, or in that the traction control device (26) and/or the compressor (27) are/is not permanently connected to the tires (15).

17. The road construction machine as claimed in claim 11, further comprising at least one of (a) the tires (15) have weights for the traction control, (b) the tires (15) are composed of a compound disk wheel, consisting of at least one wheel disk and an outer rim ring, and (c) the tires (15) each have two separate air chambers.

18. The method as claimed in claim 1, wherein the monitoring and active regulating of the traction during the operation of the road construction machine are done automatically or manually and independently of each other for each for each rear tire (15), looking in the production direction (13).
